(19) United States
(12) Patent Application Publication
(10) Pub. No.: US 2009/0070743 A1
(43) Pub. Date: Mar. 12, 2009

(54) System and method for analyzing software applications

(75) Inventors: John P. Alfors, New Brighton, MN (US); Wendy R. Bain, North St. Paul, MN (US); Barbara A. Christensen, Lino Lakes, MN (US)

Correspondence Address: UNISYS CORPORATION, UNISYS WAY, MAIL STATION: E8-114, BLUE BELL, PA, 19424, US

(73) Assignee: Unisys Corporation

(21) Appl. No.: 11/980,902

(22) Filed: Oct. 31, 2007

Related U.S. Application Data
(60) Provisional application No. 60/993,120, filed on Sep. 10, 2007.

(51) Int. Cl. G06F 9/44

(52) U.S. Cl. 717/125; 717/128

(57) ABSTRACT

Techniques are provided to analyze software applications, and in particular, to obtain visibility to the execution of a database application. As the software application issues requests to a database, the system determines based on a first set of programmable parameters whether the requests are of a type to trigger data collection. If so, a second set of programmable parameters are utilized to determine which data, if any, to collect for one or more sub-portions of the request. In one embodiment, the sub-portions are commands recognized by a database management system. Collected data is used to generate visual and textual models of the application.

### RELATED APPLICATIONS

This application claims priority to provisionally-filed application entitled “System and Method for Analyzing Software Applications” filed Sep. 10, 2007 having Ser. No. 60/993,120, (attorney document number RA-5870. P), which is incorporated herein by reference in its entirety.

### FIELD OF THE INVENTION

The current invention relates to systems and methods for analyzing and modeling software applications.

### BACKGROUND

Database applications can be highly complex. Such applications may access data that resides on multiple servers that are coupled together via networks and other interconnections. An application may call other applications, and each application may access the same, or different, data as compared to the other applications. The data may reside on one or more of the multiple servers.

For the foregoing reasons, understanding the interactions between multiple applications, as well as the interactions between applications and the data resources they utilize, can be very challenging. This makes it difficult to modernize those applications. For instance, it may be desirable to transform an application from a legacy technology in which it was originally written into a newer (e.g., object oriented) technology. To perform this modernization effectively and in a way that does not disrupt users, the various resources and data accessed by that application must be understood.

Similarly, it may be necessary to enter changes and make additions to an existing application as new requirements are identified. This requires the existing code to be fully understood so that the changes do not affect the current functionality in an unforeseen manner.

The ability to adequately support an application likewise requires an understanding of the flow of an application as well as a knowledge of the interdependencies between that application and other applications and data. Especially in the case of older applications, it is quite likely that the documentation needed to provide this understanding is not adequate. Additionally, the personnel that were involved in the development of the application may no longer be available for consultation.

Even making changes to the infrastructure of a data processing complex requires some understanding of the requirements of the various applications that run on that system. For instance, if execution of a particular application requires access to one or more mass storage devices, it is likely undesirable to perform maintenance on those devices while the application is running.

Obtaining visibility to the inner-workings of applications may further be useful if a business wants to employ business rules to control operations. As an example, assume an import/export business wants to import a particular product during the first half of the year. However, during the six months of the year when prices for the product are known to generally increase, the business wants to instead import a substitute product. To automate this change in procedure, the business wants to define programmable business rules which, prior to the start of the second half of the year, will be used to automatically update all applications that order inventory. To facilitate this, it must first be determined which applications and which databases are involved in the placing of the affected orders. This may not be readily apparent. Therefore some visibility must be gained into the relationships between the applications and databases so that meaningful business rules may be defined.

For at least the above-described reasons, techniques are needed to analyze existing database applications, determine the resources and data accessed by those applications, identify other applications that are called by the applications, and so on, so that support, maintenance, modernization, and other related activities may be performed in a cost-effective manner that minimizes disruption to users and does not result in loss of data.

### SUMMARY OF THE INVENTION

Techniques are provided to analyze software applications. In particular, the disclosed system and method may be employed to obtain visibility to the execution of a database application. The system collects data involving requests that are issued by the database application. The system further collects data describing responses received by the application, as may occur in response to requests. The collected data may then be automatically analyzed by various tools.

In one embodiment, the collected data is submitted to a visual modeling tool to obtain a pictorial representation of the execution of the application. This visual representation may include information such as which data processing systems, networks, databases, and other resources were accessed by the application. The tool may be even more specific, containing information describing the database tables, table rows, table columns, and even the contents of specific cells that were accessed by the application. Additional information contained in the pictorial representation may describe whether other applications were executed as a result of calls made by the application under analysis, which subroutines, functions, and other internal software resources were accessed and used by the tracked application, and so on.

Collected data may also be submitted to a tool that automatically generates a text-based description concerning operation of the application. The description contains information similar to that provided in the pictorial representation, but which is presented in a text-based format.

According to the current invention, the system for capturing data is closely coupled to the application under analysis. In one embodiment, as that application issues requests to a database management system (DBMS), the inventive system intercepts these requests. These application requests are tested to determine whether they are of a type that should trigger data collection. This determination is made based on request collection parameters that are selectable by an authorized user, such as a system administrator or system architect.

In a preferred embodiment, the system not only intercepts application requests that are issued by the application to a DBMS, but intercepts the requests submitted by an end-user to the application. That is, when a user submits a request to prompt execution of the application, this user request is intercepted to determine whether that user request should prompt data collection. As in the case with application requests, the determination as to whether a user request should prompt data collection is made based on the request collection parameters that are selectable by an authorized user.

The request collection parameters may include any parameters that describe a type of user request or a type of application request. For instance, one or more names of software applications that are to be analyzed may be included in the request collection parameters. As a result, any user request directed to one of the identified applications (and that also satisfies all other request collection parameters) will trigger data collection.

Other examples of request collection parameters include a user identifier (i.e., a User ID) and/or the identifier of a user interface device (e.g., the IP address of a personal computer) that issued a user request to an application. Still other exemplary request collection parameters may include a type of run from which a user request was issued (e.g., demand mode, batch mode, background mode, etc.)

The request collection parameters may further specify data identifiers, such as a name of a database table (that is, a report). Any time any access occurs to the identified table, including a store or retrieval to the table, data collection will occur. The data identification may be further narrowed by specifying a particular row (record) or column of an identified table. Any access to the specified row or column will trigger data collection. If desired, a range of table records may be specified using a column key value. For instance, a range of social security numbers could be specified such that data collection will be triggered when any access occurs to a record of an identified table having as its primary key value a social security number in the selected range of values.

A data identifier may specify a collection of tables that are known as a “Drawer”. For instance, multiple tables that all relate to a business' inventory may be grouped together in a “Drawer” that is identified for data collection purposes. Any time any access occurs to this Drawer, data collection occurs. Similarly, multiple Drawers may be grouped together as a “Cabinet”. A user may identify a Cabinet for use in triggering data collection. Alternatively or additionally, an entire database including multiple cabinets may be identified, such that any access to the database will trigger data collection. Even a database type may be identified such that any access to a database of that type will trigger data collection.

Request collection parameters may also include other indicators such as the times of day that data collection is to be initiated. For instance, a collection parameter may be set to a value that causes data collection to be enabled at 9:00 EST every day. Another parameter may be used to select collection duration as “one hour” so that collection continues until 10:00 EST every day. Collection will occur for all user requests submitted within this one hour period. Additionally, if other parameters are used to further qualify the requests, collection occurs only for those requests submitted during the designated time window and that also satisfy all other specified parameters (e.g., user id, etc.). In a similar manner, days of the week and dates may be included in the request collection parameters instead of, or in addition to, the times of the day.

In the foregoing manner, virtually any type of parameter that may be used to identify a type of user request may be selected as a request collection parameter. Additionally, any type of parameter that identifies an application request may be used for this purpose. For instance, an application request that is issued by an application to a DBMS may identify a script name, a function type, a data type (in the manner described above), another application, and so on. Any attribute of this type that is associated with an application request may be specified by the request collection parameters and used to trigger data collection. For instance, data collection may be triggered for any application request that calls a certain function, and so on.

In one embodiment, the request collection parameters may contain Boolean logic (e.g., “AND”, “OR”, “NOT”, etc.) to interrelate multiple collection parameters. One Boolean operator may be designated as the default operator that interrelates all parameters. If the default operator is selected to be “AND”, all request collection parameters must be satisfied before data collection is triggered for a given user or application request. If the default operator is instead “OR”, any one of the request collection parameters must be satisfied in order to trigger data collection.

More complex Boolean equations may be defined to interrelate request collection parameters, if desired. Such equations may include any number of hierarchical levels in combination with any number of Boolean operators.

The request collection parameters are used to select which requests will trigger data collection. In one embodiment, a second set of parameters is used to determine, for each request for which data collection has been triggered, which data will be collected. This second set of parameters is referred to as “command collection parameters”. In this embodiment, each application request is translated before it is submitted to a database. This translation generates one or more request sub-portions that each contains a command. The commands contained within the request sub-portions are executable by a DBMS, which may be the Business Information Server (BIS) commercially-available from the Unisys Corporation. According to one aspect of the invention, for each command contained within a request sub-portion, the command collection parameters determine which information should be collected for that command.

The command collection parameters are selected by an authorized party such as a system architect. Types of information that may be collected include, but are not limited to, a system name, a file name, a table identifier, a table column, a table row, a name of a report that will be run to obtain data from a database, a record range that is used to run a report, a named subroutine, a script name, an object name, a data name, a communication path identifier such as a network name, and an identifier of a device queue such as a print queue. Other information may include the names of other applications that will be invoked as a result of command execution. Any data and/or parameter values included within, or associated with, one of the request sub-portions, which in one embodiment is a command, may be specified for collection.

Similarly, information pertaining to responses that are returned to the DBMS as a result of command execution may be collected. This information may include the types and values of data that is returned with the database response, errors returned with the response, other status information, and so on.

The current invention allows data collection to be very closely controlled. Data collection will only be triggered by those application requests and/or user requests that have been selected by an authorized user. Moreover, the data that is actually collected is limited to specific information selected for each request sub-portion, which in the embodiment described above is a “command”. As an example, a user may be attempting to determine to which databases an application stores data. According to this scenario, an authorized user may decide to use the request collection parameters to enable data collection only for those application requests issued by the application of interest. Moreover, the authorized user may further set up the command collection parameters so that information will only be collected for those commands that involve the storing of data, with no data being collected for all other commands that do not involve the storing of data. The user is thereby allowed to select as much, or as little, data as desired for as many, or as few, request sub-portions (e.g., commands) as are determined to be of interest. This allows a user to very closely control which data is retained so that large amounts of unwanted data are not collected. This makes subsequent data analysis, as when generating the pictorial and text representations of the application, much more efficient.

In one embodiment, the invention relates to a system for analyzing a software application. This system includes collection enabling logic coupled to intercept application requests issued by the software application, and to determine based on a first set of programmable parameters, whether data collection is to occur for the application requests. The system further includes data selection logic coupled to receive the application requests, and if the data collection is to occur, to determine based on a second set of programmable parameters the data that is to be collected for each of one or more portions of the application request. The system also comprises retentive storage coupled to store the data to be collected to a file for analysis.

Another embodiment of the invention relates to a computer-implemented method for analyzing a software application. The method includes receiving a user request to initiate execution of a software application, and in response to the user request, issuing by the software application an application request. Also included in the method is determining based on a first set of programmable parameters, whether at least one of the user request and the application request are of a type that is to trigger data collection. The application request is then translated into one or more request portions. The data associated with selected ones of the one or more request portions is stored for use in analyzing the software application.

Yet another embodiment relates to a digital medium for storing instructions to cause the data processing system to execute a method. The method includes issuing by a software application an application request, and determining based on a first set of programmable parameters, whether the application request is of a type to trigger data collection. The application request is translated into one or more request portions. A second set of programmable parameters is used to determine, for each of the one or more request portions, if data is to be collected for analysis for the portion, and if so, which data is to be collected for analysis of the portion. For each of the one or more request portions, any data to be collected for the portion is stored for use in analyzing the software application.

Other scopes and aspects of the invention will become apparent to those skilled in the art from the following description and the accompanying drawings.

### BRIEF DESCRIPTION OF THE DRAWINGS

FIG. 1 is a block diagram of one embodiment of a system that may usefully employ the current invention.

FIG. 2 is a block diagram of one embodiment of a system according to the current invention.

FIG. 3 is a block diagram that illustrates one embodiment of processing collected data according to the current invention.

FIG. 4 is a table providing exemplary request collection parameters.

FIG. 5 is a flow diagram illustrating one method of initializing a system according to the current invention.

FIG. 6 is a flow diagram illustrating one method of collecting data according to the current invention.

FIG. 7 is a block diagram that illustrates one embodiment of processing collected data according to the current invention.

FIG. 8 is an exemplary visual model of an application according to the current invention.

FIG. 9 is a table containing an exemplary excerpt from a text file according to the current invention.

### DETAILED DESCRIPTION OF THE INVENTION

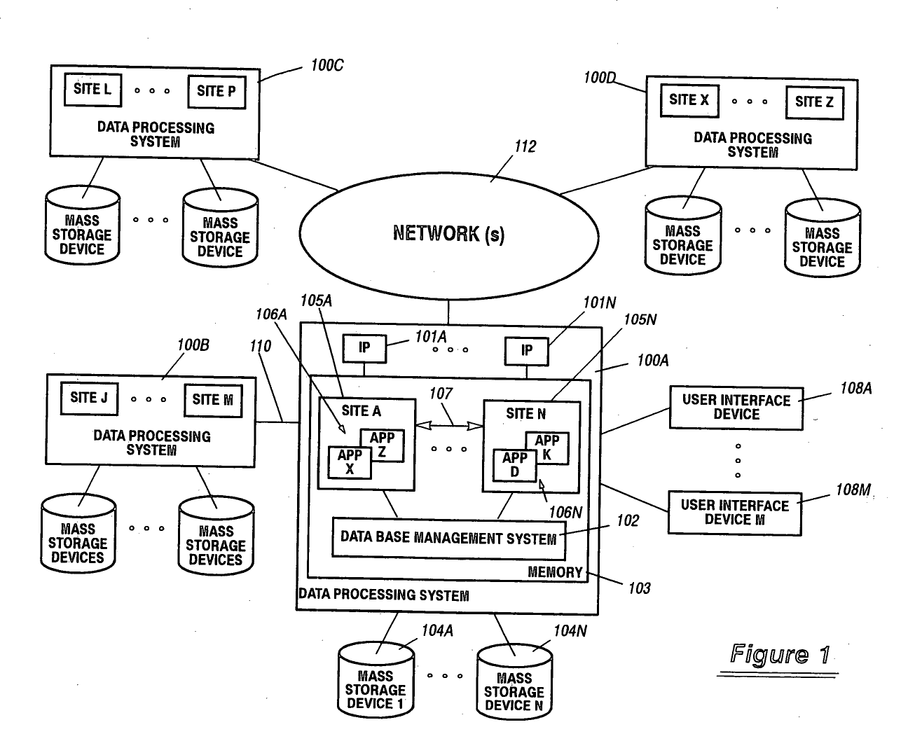

FIG. 1 is a block diagram of one embodiment of an environment that may usefully employ the current invention. This environment includes a data processing system 100A, which may be a main frame system or any other type of server known in the art. For example, this system may be a ClearPath™ server commercially-available from Unisys Corporation. Such a system may include one or more instruction processor (IPs) 101A-101N, and at least one memory 103 coupled to the IPs.

Data processing system 100A hosts a DataBase Management System (DBMS) 102 shown loaded into memory 103. DBMS provides access and support functions to one or more databases stored on mass storage devices 104A-104N. These databases may include any one or more types of databases known in the art, including those commercially available from the DB2, Oracle, Sybase, and Microsoft Corporations. In one embodiment, the database is RDMS commercially available from the Unisys Corporation.

In one implementation, DBMS 102 includes a set of software programs that controls the organization, storage and retrieval of data. This data may include fields, records and files residing in the one or more databases that interface with DBMS 102. DBMS also controls the security and integrity of these databases. DBMS may be a system such as the Business Information Server™ (BIS) commercially-available from the Unisys Corporation, as will be described further below.

DBMS 102 interfaces with one or more sites, shown as sites 105A-site 105N. Each site contains software applications, data, and other control structures that are associated with, and access, a corresponding database. For instance, site A may contain software applications 106A and other data that access a Sybase database. A different site N may contain applications 1 06N that access an Oracle database, and so on. Each site may contain any number of software applications, each of which gains access to the data stored within the associated database by making requests to DBMS 102.

Software applications running on one site may communicate with, and exchange data, with those residing on other sites. For instance, one of applications 106A may make a request to one of applications 106N running on a different site, as represented by arrow 107. Such a request may result in the return of data from that other site.

Also coupled to data processing system 100A are one or more user interface devices 108A-108M. These devices may be workstations, personal computers, “dumb” terminals, hand-held devices, and so on, that are coupled to data processing system 100A via wired or wireless connections. User interface devices may be employed by users to submit user requests to one or more of the applications on any of the sites. Such user requests may involve the storing or retrieval of data to one or more of the databases stored on mass storage devices 104A-104N. In a preferred embodiment, data processing system 100A provides a multi-user environment that may receive and execute requests from multiple users at once.

Data processing system 100A may be directly coupled to one or more other data processing systems such as data processing system 100B by direct communication links such as interconnection 110. One or more sites may reside on this other system, each including one or more applications. Each data processing system may further host a DBMS (not shown) that is the same as, or different from, that hosted by data processing system 100A. Likewise, data processing system 100B may be coupled to one or more mass storage devices, and may host one or more databases that are of a same, or a different type, as compared to the databases hosted by data processing system 100A.

Data processing system 100A may further be coupled via one or more networks 112 to additional data processing systems 100C-100D, which may be of a similar, or a different, architecture compared to that of data processing system 100A. Networks 112 may include one or more intranets, Local Area Networks (LANs), Wide Are Networks (WANs), wireless networks, the Internet, or any other one or more networks known in the art.

Data processing systems 100C-100D, like data processing systems 100A and 100B, may host a respective DBMS. Each such DBMS may interact with multiple sites, each including one or more applications and associated data. Each data processing system may be coupled to one or more user interface devices and to mass storage devices and may host one or more databases.

It will be appreciated that the system of FIG. 1 is merely exemplary, and many other system architectures and configurations may usefully employ the current invention.

Next, assume that a user of one of user interface devices 108A-108M makes a user request directed to one of applications 106A on site 105A of data processing system 100A. As a result of this request, the application begins making application requests to DBMS 102 to access data. The data may reside in mass storage devices 104A-104N, or in some cases, may reside in one or more of the mass storage devices directly coupled to one of the other data processing systems 100B-100D. In addition, the application or DBMS 102 may initiate execution of one or more other applications residing on the same site, on a different site of the same data processing system, or on a different data processing system. Which data, applications, and systems that are involved in processing this request may depend on the input parameters that the user supplied with the initial user request to the application of site 106A. Attempting to predict how this execution will proceed solely based on the source code and limited documentation for that application may be challenging, if not impossible. Therefore, what is needed is a tool that will aid in this endeavor.

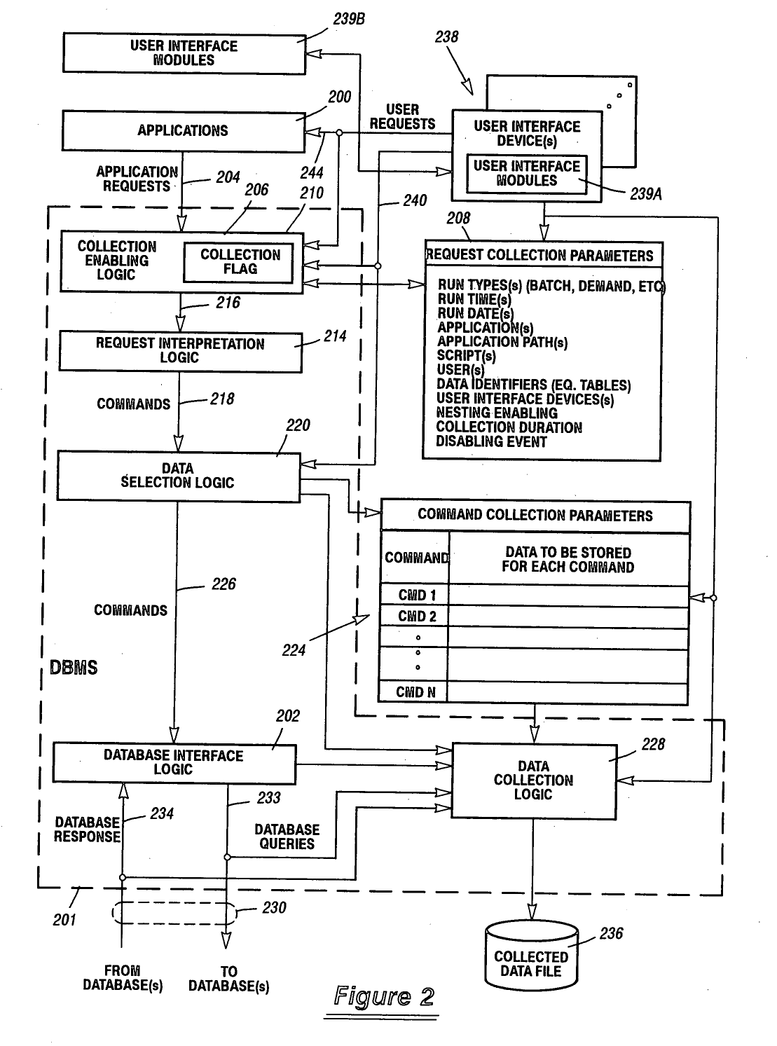

FIG. 2 is a block diagram of one embodiment of a system according to the current invention. This system provides an automated mechanism for collecting data that is used to analyze how an application is executing, including the resources that are accessed during execution. This system may reside on a data processing system such as data processing system 100A of FIG. 1.

The system shown in FIG. 2 includes applications 200, which may be assumed to reside on one or more sites in the manner shown in FIG. 1. As was the case in FIG. 1, applications 200 submit application requests to a DBMS 201 to perform data manipulation operations to one or more databases (not shown in FIG. 2). In FIG. 2, the issuance of these requests by applications 200 occurs via an interface represented by line 204. According to the invention, these requests are issued to DBMS 201 (shown dashed).

In one embodiment, the application requests presented on interface 204 are presented in the form of scripts written in a fourth-generation language (4GL). These scripts supports highly-complex and flexible data manipulation operations. When DBMS 201 is BIS™ commercially-available from Unisys Corporation, the requests are formatted into scripts of the type recognized by the BIS system.

As shown in FIG. 2, according to the exemplary embodiment, DBMS 201 of the current invention includes multiple logical blocks that include collection enabling logic 205, request interpretation logic 214, data selection logic 220, database interface logic 202, and data collection logic 228. The function of each of these logical blocks is described in turn below.

The application requests on interface 204 are initially presented to collection enabling logic 206. If collection enabling logic 206 is enabled (as will be the case when collection flag 210 is set to an active state), this logic determines whether the application request is of a type that should trigger data collection. This determination is made using collection parameters contained within control structure 208. These collection parameters were initialized by an authorized user who has the required system privileges, as will be discussed below.

Next, collection enabling logic 206 forwards the request to request interpretation logic 214 on the interface represented by arrow 216 along with an indication as to whether the request is to trigger data collection. In one implementation in which the request is in the form of a script as discussed above, the request interpretation logic 214 interprets the script, converting it into request sub-portions.

In one embodiment, each request sub-portion contains a command and the appropriate command parameters that will be executed by DBMS 202. As an example, in an embodiment in which DBMS is BIS, the command set includes all of the commands recognized by BIS. Example commands may include “SRH” to perform a search of a specified database table. Other example commands include “SRR” to sort a table and replace specified data following the sort function. Many commands are supported by BIS. In this manner, a single script may be translated into a relatively large stream of commands. These commands are shown being provided to data selection logic 220, as represented by interface 218. The commands are accompanied by an indication as to whether they are part of a request for which data collection is to be performed.

If a command is part of a request for which data collection is to be performed, data selection logic 220 uses data stored within a second control structure 224 to determine which types of data should be collected for that command. Control structure 224 may be in the form of a spreadsheet containing an entry (e.g., a row) for each command in the command set that is recognized by DBMS 202. Each entry identifies the type(s) of data, if any, that are to be collected for the corresponding command. The parameters contained within the spreadsheet are programmable, and will be selected by a user having the appropriate privilege levels. For instance, these parameters may be selected by a system architect during the design of the system, and are thereafter considered “hard-coded”. This allows the system provider to control which data is collected for each command, as may be desirable for security purposes.

In an alternative embodiment, the command collection parameters contained within control structure 224 may be updated by a system architect each time the system is re-configured for a new analysis task. This reconfiguration ensures that only data that is required for the analysis is retained. As an example, if only the storing (versus retrieval) of data is of interest to the analysis, the parameters in control structure 224 may be set so that data is only collected for commands that result in the storing of data. This limits the amount of data that is retained, minimizing the amount of storage space that must be allocated for data collection. Minimizing the amount of data collected further allows analysis of the data to be completed more efficiently. This will be discussed further below

The information concerning which data is to be collected for a given command may be passed by data selection logic 220 and/or control structure 224 to data collection logic 228.

In one embodiment, the stream of commands flows from data selection logic 228 to database interface logic 202 (“interface logic”) as indicated by arrow 226. In another embodiment, the stream of commands may be passed directly by request interpretation logic 214 to both interface logic 202 and to data selection logic 220 so that data selection logic and interface logic may be processing the commands in parallel.

Interface logic 202 processes a command by first determining to which database the command is directed. This is accomplished by analyzing the parameters included with the command. Interface logic 202 then translates the command into a database query that is properly formatted for the target database and the data type, as may also be determined by parameters included with the command. Interface logic 202 may also supply location information for the database that indicates which system hosts the database, which paths are to be used to access this system, and so on. Such information may include IP addresses, network names, system names, and so on.

In the foregoing manner, interface logic 202 may translate each of the commands into database queries that are issued to the databases on one or more interfaces illustrated collectively as interfaces 230 (shown dashed).

Interface logic 202 provides data collection logic 228 with visibility into which database queries correspond to a given command. Data collection logic 228 uses this information in conjunction with the selected parameters contained within control structure 224 to determine which information is to be collected for the original command and/or the associated queries, if any. As each query is issued via interfaces 230 (as represented by line 233), and if information is to be collected for the original command and/or the query, data collection logic 228 stores that data into collected data file 236.

Data collection logic 228 also has visibility to any response which is returned from the database on interface 230 as a result of a query, as represented by line 234. Such responses may include data returned as the result of a query, status, error codes, and so on. Data collection logic 228 matches each response to a query using alphanumeric indicators, or tags. Data collection logic 228 may then determine which information, if any, is to be retained in collected data file 236 for a given response.

In the foregoing manner, data collection logic 228 uses the command collection parameters retained within control structure 224 to determine which of the command, query, and response data, if any, should be collected for each command. In some cases, the authorized personnel that initialized control structure 224 may have determined that no data is to be collected for a certain type of command. In other cases, only selected fields of the request and/or response will be retained, and so on.

As noted above, retained data is stored to collected data file 236, which is a file that has been allocated to store data collected for the current collection session. In one embodiment, collected data file 236 is implemented as two buffers. A first buffer is filled and then written to retentive storage. While the storage operation is occurring, the second buffer is used to receive the data, and so on. In this manner, several smaller memory buffers may be utilized to receive very large amounts of data, with the contents of each buffer being periodically stored to mass storage for later analysis.

Data collection will continue for a particular session until some terminating event occurs. For instance, a user with the required user privileges may enter a command such as a “STOP” command from one of user interface devices 238 to terminate data collection, as will be discussed further below. Entering of this command will, in one embodiment, cause collection flag 210 to be cleared and will disable collection enabling logic 206 and data selection logic 220 via the interface represented by arrow 240. Alternatively, request collection parameters may be specified by an authorized user to automatically disable data collection after a predetermined period of time, or after some other event occurs, such as a particular request being received from an application.

Once data collection is disabled, the data stored within data collection file 236 may be analyzed. In one embodiment, this involves automatically generating a file which is in a format that can be used as input to a visual modeling tool such as Rational® Rose® which is commercially available from the IBM Corporation. Such visual modeling tools are used to generate a pictorial representation of the way in which the application executed as well as which data and other resources were involved in execution. Alternatively or additionally, the data stored within file 236 can be manipulated and used to generate a text file that describes the operation of the application. The resulting pictorial and/or text files can be utilized to understand which resources (e.g., systems, communication paths, databases, database tables, table rows, table columns, etc.) are accessed by the application, how this application inter-relates to other applications, and so on. This information can then be used to modernize the application, to make changes and/or additions to the application, perform maintenance to the system without impacting application execution, develop automated business rules that optimize the operations of a business entity, and so on.

Before discussing how the data contained within collected data file 236 is analyzed, a further discussion is provided concerning how the system is prepared for data collection. In one embodiment, control structure 224 may be enabled by a system architect stationed at one of user interface device(s) 238. This individual may sign on to the data processing system on which applications 200 are executing. This may be data processing system 100A of FIG. 1, for instance. User interface device(s) 238 may comprise personal computers, workstation stations, dump terminals, hand-held computing devices, and/or any type of devices that allows the system architect to enter data into control structure 224.

After gaining access to the system, user interface modules 239A and 239B (“user interface modules 239”) provide the necessary functionality to allow the authorized user to supply the data needed to populate control structure 224. User interface modules 239 may include Active Server Pages, web pages written in hypertext markup language (HTML) or dynamic HTML, Active X modules, Java scripts, Java Applets, Distributed Component Object Modules (DCOM), and the like.

In one embodiment, user interface modules 239 are limited to “client-side” user interface modules residing on user interface device(s) 238. In another implementation, these user interface modules could reside solely on a server (e.g., data processing system 100A). Alternatively, some user interface modules could reside on the user interface devices 238 while others reside on the server. These user interface modules may be of a type that provides a graphical user interface (GUI) which allows the authorized party to enter the input parameters to populate control structure 224.

As noted above, control structure 224 may be a spreadsheet that contains an entry (e.g., a row) for each command that is recognized by interface logic 202. The entry will further describe which, if any, information is to be collected when that command appears in the command stream on line 226 and collection is enabled. Types of information that may be collected include, but are not limited to, a system (e.g., server) name, a file name, a table identifier, a table column, a table row, a name of a report that will be run to obtain data from a database, a record range that is used to run a report, a named subroutine, a script name, an object name, a data name, a communication path identifier such as a network name, and an identifier of a device queue such as print queue(s). Other information may include the names of other applications that will be invoked as a result of command execution. Any data and/or parameter values included either with the commands when the commands are provided to interface logic 202 or which are included with the queries when the queries are issued, may be selected for retention. Similarly, information pertaining to the query response may be collected, including the types and values of data that is returned with the database response, errors returned with the response, other status information, and so on.

As may be appreciated, the types of data that are selected for collection will depend on the purpose of the collection. As an example, a user may be attempting to determine to which databases a particular application stores data. In this case, for each command that involves the storing of data, the user will initialize control structure 224 to collect only the parameter(s) that identify the database(s) to which the store operation is occurring. The authorized user may decide not to collect any data at all for all other commands that do not involve the storing of data. The user is allowed to select as much, or as little data, as desired for as many, or as few, commands as are determined to be of interest. This allows the user to very closely control which data is retained so that large amounts of unwanted data are not stored to file 236. This makes data analysis much more efficient, and reduces the amount of storage space that must be allocated for file 236, as discussed above.

The foregoing discussion describes an embodiment wherein an authorized user such as a system architect is allowed to enter data directly into control structure 224 from a user interface device 238. Alternatively, an authorized user may enter this data into a file and then initiate a script to copy the data from the file into control structure 224. In yet another scenario, some other type of utility program may be used to load control structure 224 with the data.

After control structure 224 has been initialized in the desired manner based on the purpose for the data collection, the authorized user may likewise initialize the request collection parameters stored in control structure 208. As discussed above, the request collection parameters are used by collection enabling logic 206 to determine when data collection is to be triggered for a given request. The request collection parameters may include any type of descriptor that is associated with, or identifies, a user request that a user makes to one of applications 200 on interface 244. Collection enabling logic 206 has visibility to these user requests for enabling purposes via interface 244.

Examples of parameters that may identify user requests include data that identifies a user (e.g., via user IDs, for instance). When a userid is specified, any request issued by that user to an application will then trigger data collection. Alternatively or additionally, the parameters may identify one or more user interface devices 238 via information that may include IP addresses or some other address information. Any request originating from an identified user interface device will trigger collection. Similarly, one or more names of applications 200 may be identified such that any user request directed to one of the identified applications will trigger data collection.

Other request collection parameters include run types. For instance, a user request may be submitted via interface 244 by a user executing in “demand” mode, meaning the user is waiting for a response to this request from the data processing system. Alternatively, application execution may be initiated as a result of a request that is submitted automatically by a scheduler program using a “batch” mode. This may occur, for example, at a selected time of day or night. Similarly, application execution may occur in a “background” mode, which means that the operating system will allocate the application run-time when system demand drops below some predetermined level. Other operating modes may be possible in various types of systems. If the request collection parameters specify a run-type mode, only those user and/or application requests that are initiated during the selected mode(s) and that satisfy other selected criteria will trigger data collection.

In one embodiment, when multiple parameters are specified, they are interrelated by the Boolean operator “AND” by default. That is, if an application, a user, and a user interface device are all specified as data collection parameters, data collection will be initiated when all conditions are met. As an example, assume a request specifies an application identifier of “Application1”, a user id of “Monty_P”, and a user interface device having an IP address of “IP_X”. Data collection will be initiated only for those requests from the specified user id that originate from the identified IP address and that make requests to Application 1. This may be represented by the logical expression:

(Application=Application1) AND (Userid=Monty_{—}P) AND (IP_Address=IP_{—}X)

In one embodiment, one or more other Boolean operators may be used to inter-relate collection parameters, as will be discussed below.

According to one aspect, a user may be allowed to further identify a path of an application in addition to the application itself. An application path relates to a particular flow of execution that is taken during execution of an application. For instance, assume that an application has one body of code that is executed when a data store operation is being performed, and another set of code that is executed when data is retrieved from a database. The set of code that will be executed is determined by the combination of parameters supplied with the user request. The authorized user therefore not only employs the request collection parameters to select an application name, but also to select the combination(s) of input parameters supplied with a user request. Only those identified combinations will trigger data collection.

As an example of the foregoing, assume that a particular application may store data to, or retrieve data from, any one of several databases based on request parameters supplied when calling the application. Assume this request takes the following format:

Application1 (store, data1, databases).

The supplied parameters cause Application1 to store “data1” to database 1. That is, Application1 takes the execution path that involves storing data to database1. To enable data collection for only this execution path of Application1, the user specifies “Application1”, “store” and “database1” within the request collection parameters. Data collection will only be triggered for user requests directed to Application1 that contain the “store” and “database1” parameters. One or more execution paths may be selected for a given application by specifying corresponding combinations of input parameters. If a combination of input parameters is specified, data collection only occurs for the identified path(s). If no combination of input parameters is specified, data collection occurs for all paths.

It may be noted that in order for an authorized user to select an execution path (i.e., by selecting a combination of input parameters), that user must have a somewhat detailed knowledge concerning how an application is executed (e.g., an understanding of the available input parameter combinations, and so on). In many cases, the authorized user will not have this level of knowledge. In this case, data collection can be controlled in a similar manner simply by controlling which types of requests are issued on interface 244. For instance, if analysis is being performed to explore how store operations are being accomplished, only store-related requests are issued on interface 244.

The request collection parameters may further specify data identifiers, such as a name of a database table (that is, a report). Any time any access (e.g., a store or retrieval) occurs to the named table, data collection will occur. The data identification may be further narrowed by specifying a particular row (record) or column of an identified table. Any access to the specified row or column will trigger data collection. If desired, a range of records may be specified using a column key value. For instance, a range of social security numbers could be specified. As a result, data collection will be triggered when any access occurs to a record of an identified table having as its primary key value a social security number in the selected range of values.

A data identifier may specify a collection of tables that are known as a “Drawer”. For instance, multiple tables that all relate to a business' inventory may be grouped together in a “Drawer” that is identified for data collection purposes. Any time any access occurs to this Drawer, data collection occurs. Similarly, multiple Drawers may be grouped together as a “Cabinet”. A user may identify a Cabinet for use in triggering data collection. Alternatively or additionally, an entire database may be identified, such that any access to the database will trigger data collection. Even a type of database may be identified such that any access to a database of that type will trigger data collection.

In one embodiment, data identification may involve identifying the location of data by specifying hardware components. For instance, a user may identify a data processing system on which the data of interest is located, a network which is accessed to obtain the data, a mass storage device (e.g., a disk) that is accessed to obtain the data, or some other hardware component that is accessed to obtain the data. Whenever any of the identified hardware components are accessed to obtain data, data collection is triggered. This would, for instance, allow data collection to be triggered for each access to a particular mass storage device.

Data identification in the aforementioned manner provides important security benefits. For instance, it may be desirable to determine which users, user devices, applications, etc. are accessing a particular body of data. This information may be used to ascertain whether impermissible operations are somehow occurring, to monitor which users are updating data, to ensure that appropriate privilege levels are granted to users who require access to certain data, to improve overall security of the system, and so on.

Data identification may also be used to improve system performance. For instance, once the access patterns for groups of data are established, the data may be stored on selected mass storage devices to spread demand across data processing systems, networks, and etc. so that access times can be minimized.

Request collection parameters in control structure 208 may include other indicators such as the times of day that data collection is to be initiated. For instance, a collection parameter may be set to a value that causes data collection to be enabled at 9:00 EST everyday. Another parameter may be used to select collection duration at “one hour” so that collection continues until 10:00 EST everyday. Collection will occur for all user requests submitted within this one hour period. Additionally, if other parameters are used to further qualify the requests, collection occurs only for those requests submitted during the designated time window that also satisfy these other specified parameters (e.g., user id, etc.). In a similar manner, days of the week and dates may be included in the request collection parameters instead of, or in addition to, the times of the day. In this manner, virtually any type of parameter that may be used to describe a user request may be selected to enable data collection.

In addition to selecting which user requests will trigger data collection, the request collection parameters in control structure 208 may also be used for selecting which application requests on interface 204 will trigger that collection. As discussed above, in one embodiment, requests on interface 204 are issued from an application in the form of a script that may be a 4GL script recognized by DBMS 201. Many different scripts may be used by a single application. An authorized user may select one or more script names as a way to indicate that data collection should be enabled for the requests associated with those scripts.

In one embodiment, an authorized user may decide whether “nesting” is enabled such that data collection occurring as a result of execution of a first application will continue if that first application initiates execution of other applications. For instance, a first application may execute a command such as a “START” command (supported on some ClearPath™ systems commercially available from Unisys Corporation) that will initiate execution of a second application. If “nesting” is enabled in the request collection parameters, and if data collection is occurring for the first application, collection enabling logic 206 will enable data collection for the second application in the same way it is enabled for the first application. If nesting is disabled, collection will be discontinued during execution of any other applications initiated by the first application, unless the collection parameters specifically enable that collection (e.g., the collection parameters specifically list that second application as one for which collection is enabled.) The use of this nesting feature provides visibility into the interaction between multiple applications.

As discussed above, in one embodiment, an authorized user may utilize Boolean logic to interrelate multiple collection parameters. For instance, the interrelation of parameters via a Boolean “AND” operator may be represented by the logical expression:

(Application=Application1) AND (Userid=MontyP) AND (IP_Address=IP_{—}X)

This expression indicates that data collection will be initiated when the user having the user id of “Monty_P” submits requests to “Application1” from the user interface device having the IP address of “IP_X”. In this embodiment, a user may be allowed to select other logical operators to interconnect parameters, including “OR” and “NOT” operators. In this manner, complex Boolean equations may be written that include any factors that have been pre-defined in the system to describe a request to initiate application execution. For example, an authorized user may write the following expression:

(NOT(IP_Address=IP_{—}X)) OR (Userid=Monty_{—}P)

This expression represents the scenario wherein collection is triggered for all user requests that come from the user having an id of “Monty_P”, or from all user interface devices that have an IP address other than that of “IP_X”. Complex expressions having multiple hierarchical levels may be defined using parenthesis. Definition of such equations may be supported by GUI operations provided by user interface modules 239.

The foregoing discussion of collection parameters identifies some of the exemplary criteria that may be used to trigger data collection. The list of parameters discussed above will be understood to be merely exemplary, and any other parameters that could be used to describe and select a user request on interface 244 or an application request on interface 204 may be used instead of, or in addition to, those discussed herein.

The selection of collection parameters may be facilitated by user interface modules 239. These user interface modules may be adapted to provide users with the options that are available for each parameter type. For instance, a Graphical User Interface (GUI) may be provided that includes a drop-down menu to allow an authorized user to display all available user interface device IDs within the system. Another drop-down menu may be provided to display all available application names. Yet another menu may be provided to allow an authorized user to display all user ids, and so on.

The above description focuses on the request collection parameters that select the requests that will trigger data collection. In one embodiment, the request collection parameters may further be used to select a disabling event that will stop data collection. For example, a disabling event may be the occurrence of a particular type of user request on interface 244 or a type of application request on interface 204. That request may be identified using any of the request parameters described above, or any other type of descriptor for categorizing a request. Boolean logic may be used to interrelate multiple parameters for purposes of defining the disabling event. When a request of the identified type is received on interface 204 or interface 244 by collection enabling logic 206, this logic disables collection flag 210 and closes collected data file 236. As discussed above, collection may also be disabled based on a time period.

In the foregoing manner, the request collection parameters may be used to define events that will disable data collection. In one implementation, data collection is also disabled via a “STOP” command that is issued from a user interface device 238 by an authorized user. This command is received by collection enabling logic 206 via interface 244, and causes the collection flag 210 to be set to a de-activated state. As a result, data collection will not be initiated for any more requests. Logging will continue for any eligible requests that are executing at the time the collection flag 210 is deactivated. Thereafter, collected data file 236 is closed. In this manner, the issuance of the “STOP” command by an authorized user may be provided as another type of disabling event similar to events that are defined using the request collection parameters, as discussed above.

Other commands in addition to the “STOP” command are available to control data collection. For instance, a “START” command may be entered by an authorized user to start collection. This command is received by collection enabling logic 206 on interface 244, resulting in activation of the collection flag 210. Thereafter, all user requests on interface 244 and/or all application requests on lines 204 that satisfy request collection parameters will result in data collection. Collection will continue for all eligible requests until a disabling event occurs.

Other commands supported by the user interface of one embodiment include an “ABORT” command to immediately stop logging and abort file 236 so that the data is not saved. A “CONFIG” command is used to configure a logging session (that is, initialize the request collection parameters in control structures 208 and 224) based on parameters included in an input report identified by the CONFIG command. A “FLUSH” command is available to flush all buffered data being collected in file 236 to retentive storage so that all data collected so far can be retrieved even though the file is still open and being written. This allows analysis to begin on the data while data collection is still occurring.

Returning to a discussion on the initialization of the collection parameters, the foregoing discussion describes how an authorized party enters the collection parameters manually via interface devices 238, as by employing a GUI interface. According to another aspect of the invention, the collection parameters may be entered by executing a script. For instance, a script may be executed on one of the user interface devices 238 to copy the request collection parameters from a designated file to control structure 208 in preparation for data collection.

In one embodiment, collection parameters may also be initialized using a collection profile. Each collection profile includes a first file containing the request collection parameters to be copied to control structure 208. In one embodiment wherein an authorized party is allowed to update the command collection parameters, this profile may also include a second file containing the command collection parameters. These parameters are to be copied to control structure 224. An authorized party may cause the system to be initialized via an identified collection profile by issuing the “CONFIG” command and providing the name of the profile.

To summarize system operation, once the system is initialized with the request collection parameters and the command collection parameters and the collection flag 210 has been set (e.g., using the “START” command), any subsequently issued user requests and resulting application requests that satisfy the chosen parameters will initiate collection in the above-described manner. Collection will terminate via either the detection of a terminating event selected by the request collection parameters or a command (e.g., “STOP” command) issued by an authorized user from user interface devices 238. Thereafter, the data within collected data file 236 may be analyzed.

Collected data file 236 contains both data and configuration parameters. For instance, the file may contain all, or a subset of all, of the request collection parameters contained in control structure 208 that were used during the collection of the data. Likewise, the file may contain all, or a subset of all, of the command collection parameters contained in control structure 224 that were used to trigger data collection. Alternatively, the file may contain a name of a profile that was used to initialize the collection parameters so that the collection parameters used during data collection can be retrieved from this profile, if desired.

Other information contained within file 236 may include data that identifies an authorized user that selected the collection parameters, such as the user's user id. This data may further include the user interface device from which the collection parameters were entered and the time/date of entry. Further, as collected data is stored to file 236, corresponding time/date stamps may be added along with the data. The system may be configured to store any other data to collected data file 236 that is considered useful for analysis purposes, such as information describing the hardware on which the system of FIG. 2 is executing. The processing of the data file 236 is considered further in regards to the remaining drawings.

It will be understood that the various logic blocks of FIG. 2 may be implemented in hardware, software, firmware, or any combination thereof. In one embodiment, logic blocks 200-228 of FIG. 2 are implemented via one or more software entities executing on a data processing system such as data processing system 100A of FIG. 1. Many alternative implementations are possible. Some aspects of the invention may be implemented as digital logic circuitry. Those skilled in the art are readily able to combine software created as described with appropriate general purpose or special purpose computer hardware to create a computer system and/or computer subcomponents embodying the invention, and to create a computer system and/or computer subcomponents for carrying out methods embodying the invention.

A machine embodying the invention may involve one or more processing systems including, but not limited to, CPU, memory/storage devices, communication links, communication/transmitting devices, servers, I/O devices, or any subcomponents or individual parts of one or more processing systems, including software, firmware, hardware, or any combination or subcombination thereof, which embody the invention as set forth in the claims.

It may be noted that in the preferred embodiment of FIG. 2, the various logical entities that facilitate data selection and data collection according to the invention are incorporated within DBMS 201. This close coupling of the standard DBMS logic with the data collection logic allows for a system that is able to closely control which data is collected, and the operates efficiently. An external monitor would not have visibility to the types of application requests, commands, and queries that result from issuance of a particular user request, and therefore would not have the ability to control which data is collected for a particular command, for example.

Many alternative embodiments are possible within the scope of the current invention. For instance, some of the logical entities such as collection enabling logic 206, data selection logic 220, and/or data collection logic 228 may be implemented externally to DBMS 201. Additionally, while the embodiment of FIG. 2 illustrates control structures 208 and 224 as being external to DBMS 201, one or more of these control structures may be implemented internal to DBMS 201. Moreover, some of the existing logical entities shown in FIG. 2 may be combined so that a single logical structure provides multiple functions. Data processing architectures other than that shown in FIG. 1 may be employed to host this system. Thus, it will be understood that the illustrative embodiments of FIGS. 1 and 2 are merely exemplary, and many alternative embodiments are possible.

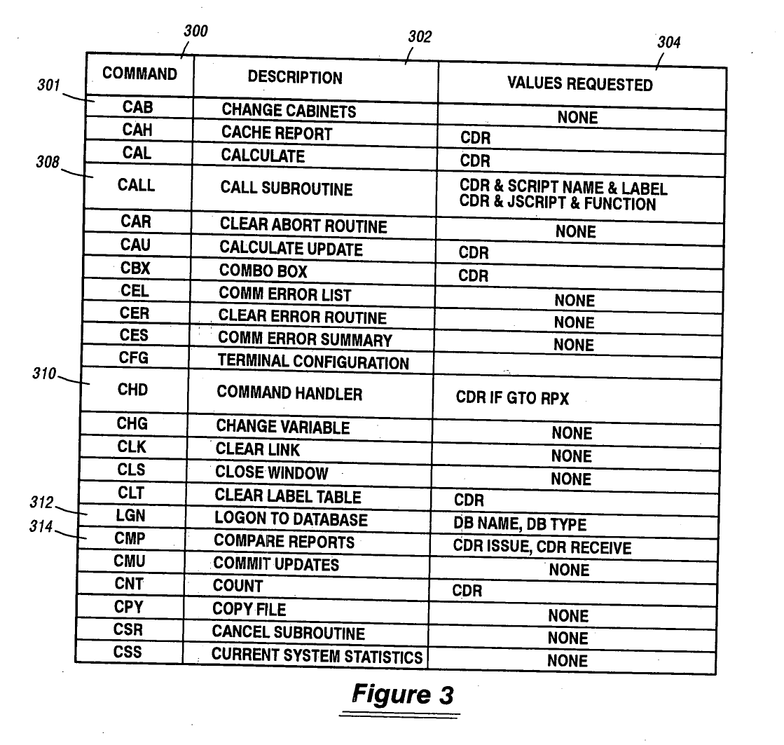

FIG. 3 is an exemplary table of a type that may be used to implement control structure 224 according to one embodiment of the invention. Each entry, or row, in the table corresponds to a respective command that is recognized by DBMS 201. For instance, row 301 stores the command “CAB”, which is a command to cause DBMS 201 to change cabinets, where a cabinet is a grouping of database tables.

The table of FIG. 3 contains several columns. Column 300 identifies the command itself. Optional column 302 provides a human-readable description of the command function. Column 304 indicates the types of data that have been selected to be stored for the command. Recall that these types of data are selected by an authorized user. In one embodiment, these values are selected once and are thereafter considered “hard-coded”. In another embodiment, a professional with the required user privileges such as a system architect may re-select these values for each data collection session. This re-selection of parameters may occur manually by signing onto user interface device(s) and entering the parameters, for example. Alternatively, the authorized party may enter this data into a file which is then used to initialize control structure 224 automatically, as by execution of the CONFIG command, or by invoking a script.

Some of the types of data that may be collected include a Cabinet/Drawer/Report (CDR), as shown in column 304 of the table of FIG. 3. A CDR indicates which database table (also referred to as a report) is being referenced by the corresponding command. That report is identified by report name, as well as the group of reports in which that report is included (“drawer”), and the group of drawers in which the report is included (“cabinet”). Thus, specifying that the CDR is to be collected for a given command indicates that when the command is executed, the report name and report grouping for the referenced report is to be stored to file 236.

In row 308, two entries are contains in column 304 for the CALL command. This indicates that the “CALL” command may be used in one of two ways. The first entry indicates that when the CALL command is used to invoke a script that is not a JavaScript, the script name and label are collected along with the CDR. The second entry of row 308 indicates that when the CALL command is used in reference to a JavaScript name, the JavaScript name and function are captured along with the CDR. In this manner, different types of data may be collected depending on the way in which the command is used, as indicated by the corresponding entry provided in column 304.

Row 310 illustrates that conditional logic may be incorporated into the statements of column 304. For instance, for command “CHD”, the CDR for the referenced data is to be stored to file 236 if the statement “GTO RPX” accompanies the command. This indicates that decisional logic may be used to determine which, if any, information is to be collected for a given command.

In row 312, when the command “LGN” appears in the command stream (a command employed to log onto a database system), the name and the type of the database (DB) that is included with the command is to be collected in collected data file 236.

Row 314 illustrates for command “CMP”, the contents of two reports are compared. In this case, the CDR for each report is saved to collected data file 236.

For one or more commands, information to be saved may be listed as “—None—” as shown in FIG. 3 column 301, for instance. This selection is made because an authorized party (e.g., a system architect) has determined there is no need to view data for that command. This allows data collection to be disabled on a command-by-command basis. Because unneeded data is not collected or stored, data collection and analysis is performed more efficiently. Moreover, not as much space needs to be allocated for file 236.

In an embodiment wherein a system architect initializes control structure 224, this authorized user will tailor the data to be collected based on the purpose of the analysis. As an example, the authorized professional may be attempting to determine which application a first application calls. In this case, for each command that involves the calling of another application (e.g., a “CALL” or a “LNK” command), the authorized party will select the storing of the name of the other application or code being called. All other commands may be designated “NONE” to indicate that no information will be collected for these commands. The authorized party is allowed to select as much, or as little data, as desired for as many, or as few, commands as are determined to be of interest for the particular analysis. This allows the type of data that is retained to be closely controlled so that large amounts of unwanted data are not stored to collected data file 236. This makes data analysis much more efficient, and reduces the amount of storage space that must be allocated for file 236.

It will be understood that the examples listed in column 304 of the table of FIG. 3 are exemplary only, and any other types of information concerning an issued command or the results of execution of that command may be selected for retention within file 236. This may include, but is not limited to, one or more of the following: a system name, a file name, a table (report) identifier, a table column, a table row, range of report identifiers, a named subroutine, a function name, a script name, an object name, a data name, a communication path identifier such as a network name, and an identifier of a device queue such as print queue(s). Other information may include the names of other applications that will be invoked as a result of command execution. Any data and/or parameter values included with the queries may be selected for retention. Similarly, information pertaining to the query response may be collected, including the types and values of data that is returned with the database response, errors returned with the response, and so on.

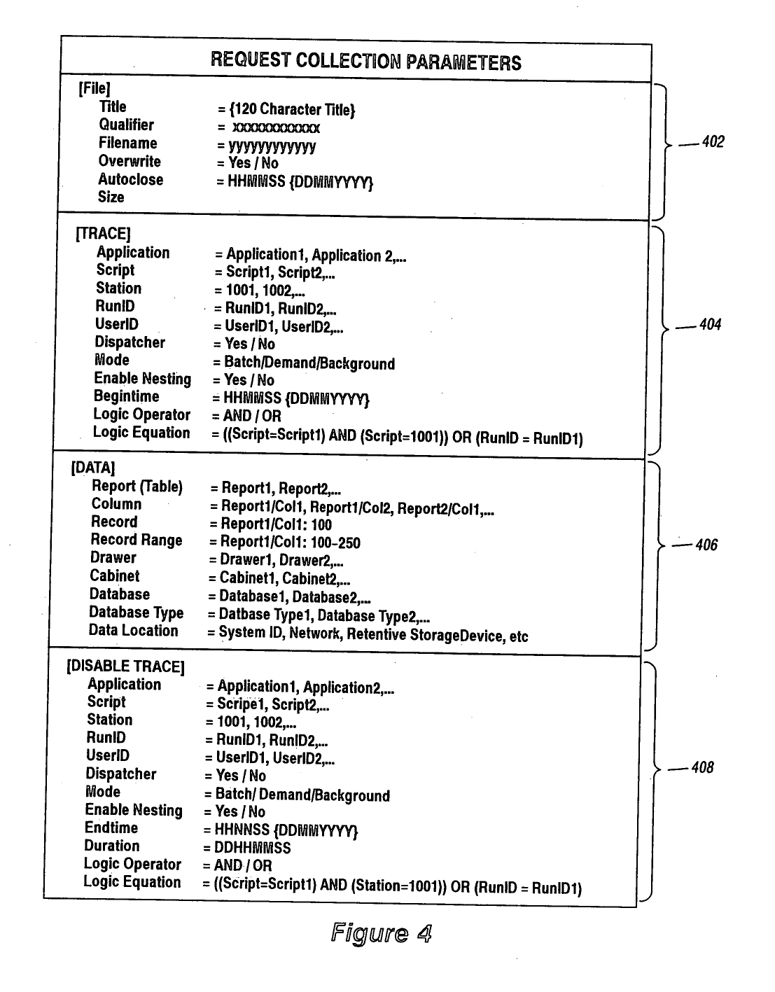

FIG. 4 is a table illustrating a table providing exemplary request collection parameters of the type stored in control structure 208 (FIG. 2). Section 402 of the table indicates descriptors that are used to create, use, and close data collection file 236 (FIG. 2). For instance, an alphanumeric qualifier and file name may be assigned for use in referencing the file. In one embodiment, a file is identified using the format “qualifier*filename”. In this section, a user may also decide whether a previously-created file may be overwritten using the Overwrite indicator. The Autoclose option allows a file to be automatically closed at a certain time and date, assuming it is open at that time and date.

The parameters in section 404 allow a user to select one or more application names and script names by providing comma-delimited lists of such names, as shown in the exemplary format. The user may further specify one or more stations (or user devices) by providing station numbers, which in one embodiment are IP addresses. One or more run IDs and/or user IDs may likewise be selected using comma-delimited lists. The user may select only those requests issued automatically by a dispatcher program, or may instead select the mode in which requests are issued (e.g., batch versus demand, etc.) The user may further select whether nesting is enabled and a time at which data collection is to begin. The user may select a default logic operator for use in interrelating multiple selected trace parameters. For instance, they may be interrelated by an “AND” or an “OR”. Alternatively, the user may define a more complex logical equation by specifying parameter names (e.g., “Application”) and the corresponding desired values (e.g., “=Application1”) that are inter-related by multiple logical operations (e.g., AND, OR, NOT.)

In one embodiment, a user may select a maximum predetermined number of parameters in the trace section 404. In one case, this maximum number is “ten”, but other maximum numbers may be selected in other implementations.

Data section 406 may further allow a user to specify data by reports (i.e., tables), columns of reports, records (rows) of reports, a record range, a drawer, cabinet, database, and/or database type. If the identified data is referenced in a user or application request, data collection is triggered. A user may identify this data by location (e.g., hardware). For instance, the user may identify a data processing system on which the data of interest is located, a network which is accessed to obtain the data, a mass storage device (e.g., a disk) that is accessed to obtain the data, or some other hardware component that is accessed to obtain the data. If any of the identified hardware components are accessed to obtain data, data collection is triggered. In one embodiment, a user may select a maximum predetermined number of parameters in the data section 404, which in one implementation is “ten”. As discussed above, whenever data of a type selected in data 404 is accessed by a user or application request, data collection is triggered for that request.

An optional section 408 may be provided to define one or more disabling events. Occurrence of one of these events will disable data collection. In one case, this occurs by deactivating a data collection flag 210 (FIG. 2). Any one or more of the parameters discussed above in regards to trace section 402 may be used to define this type of a disabling event, optionally employing Boolean logic equations.

Additionally, an end time may be selected. At this time/date, data collection will be disabled. Alternatively, a duration may be selected for collection. When a period of time equal to the specified duration has elapsed after the “Begintime” indicated in trace section 402, collection is disabled.

It will be appreciated that the table of FIG. 4 is exemplary only, and any other parameter that may be used to describe a user request, an application request, data stored within one of the databases accessed by a software application, an application itself, or any other facet of execution of a database query may be employed instead of, or in addition to, those shown.

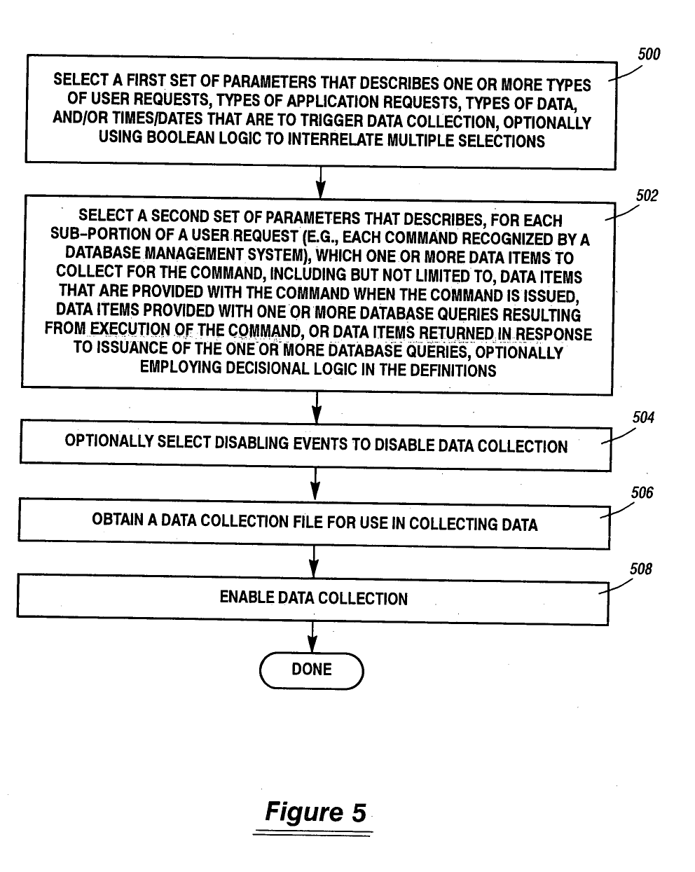

FIG. 5 is a flow diagram illustrating one method of initializing a system according to the current invention. A first set of parameters are selected, which are referred to above as the request collection parameters (500). These parameters identify one or more types of user requests, types of application requests, types of data, and/or times/dates that are to trigger data collection. The selection of request collection parameters may optionally employ Boolean logic to interrelate multiple selections.

Next a second set of parameters is defined that determines, for each of one or more sub-portions of an application request (e.g., each of the commands recognized by the Database Management System), which data to collect for that request sub-portion (502). The data may include, but is not limited to, data provided with the command when the command is issued, data provided with one or more database queries that were generated as a result of command execution, or data returned in response to issuance of the one or more database queries. Decisional logic may optionally be incorporated into the second set of parameters, as shown in row 310 of FIG. 3.

Optionally, disabling events may be selected for use in disabling data collection (504). The same types of parameters that are specified for use as request collection parameters may be used to define the disabling events. In one embodiment, when a disabling event is detected by collection enabling logic 206, that logic responds by clearing collection flag 210 so that collection will not occur for any future requests until the collection flag is re-enabled.

A data collection file may next be created, opened, and readied for use in collecting data (506). In one implementation, a user selects file parameters, such a file name and size, which are included with the other request collection parameters, as shown in FIG. 4. Finally, data collection may be enabled, as by an authorized user executing a “Start” command from a user interface device 238 to set collection flag 210.

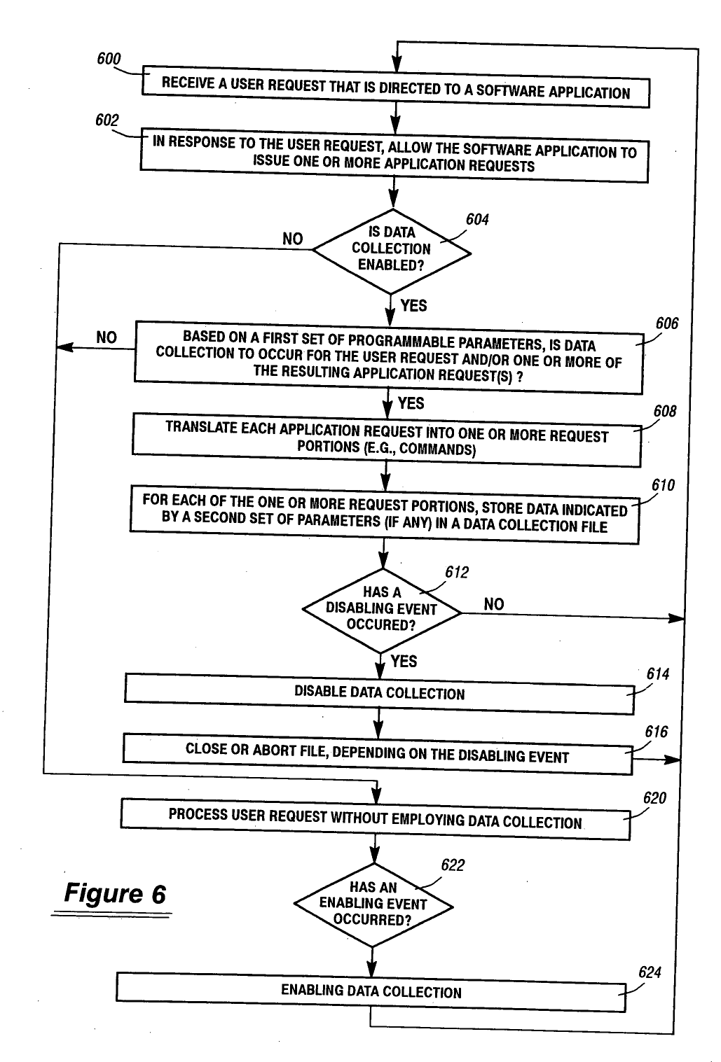

FIG. 6 is a flow diagram illustrating one method of collecting data according to the current invention. A user request is submitted that is directed to a software application (600). This request may be submitted by a user in demand mode, or may be submitted automatically by a scheduler in batch or background mode. The software application responds by issuing one or more application requests that may access a database (602). In one case, these application requests are in the form of one or more scripts. If data collection is enabled (604), a first set of parameters, which in one embodiment is the request collection parameters, is used to determine whether data collection is to occur for the issued user request and/or the one or more resulting application requests (606). If so, in one embodiment, each of the one or more resulting application requests is translated into multiple request portions (608). As one example, each such request portion may be a command that is recognized by a database management system. Then a second set of parameters, which in one embodiment is the command collection parameters, is used to determine which data, if any, is to be stored to the collected data file for each of the request portions (610).

Next, it may be determined whether a disabling event has occurred (612). For instance, this event may be a “Stop” or an “Abort” command issued from a user interface device, or may instead be an event defined within the request collection parameters. In any case, if such an event has occurred, data collection is disabled (614). In one case, this occurs by clearing collection flag 210. Depending on the event, the file may be closed in preparation for using that file for analysis purposes, or may instead by aborted (616). For instance, in the case of a “Stop” command, the file is closed. However, in the case of an “Abort” command, the file is aborted. Execution may then return to step 600 to receive additional requests, as shown by arrow 618.

Returning to decision steps 604 and 606, if data collection is not enabled, or data collection is not to occur for the user request or the resulting application request(s), processing continues to step 620, where the request is processed without collecting data. Next, if an enabling event is detected (622), as may occur if an authorized user executes a “Start” command, data collection is enabled (624). Execution may then return to step 600 to receive additional user requests.

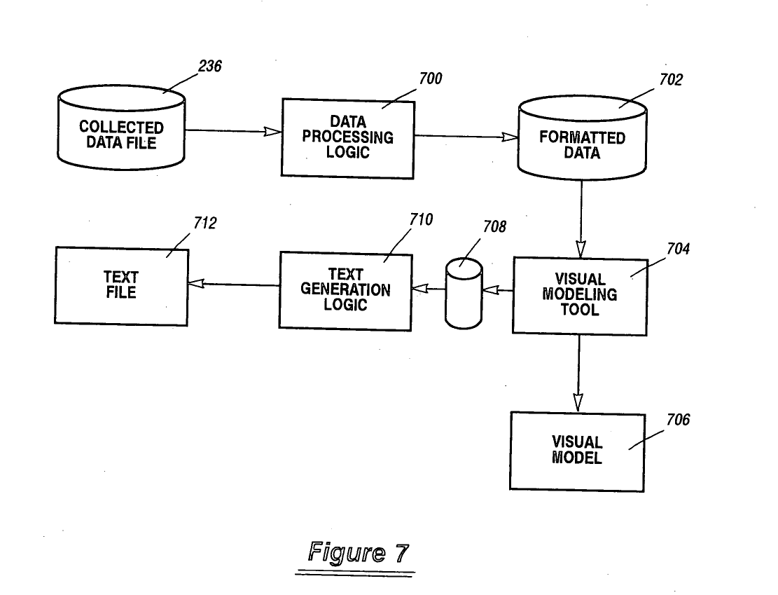

FIG. 7 is a block diagram that illustrates one embodiment of processing collected data according to the current invention. The data is contained in file 236, and is processed by data processing logic 700. In particular, data processing logic re-formats and parses the data into formatted data 702, which in one implementation is in the extensible Markup Language (XML) format.

The formatted data must be in a format that is compatible with a selected visual modeling tool 704 that will be used to convert this data into a visual model 706. In one embodiment, the visual modeling tool 704 is Rational® Rose® commercially-available from the IBM Corporation. As is known in the art, Rational® Rose® is an object-oriented Unified Modeling Language (UML) software design tool. It can be used to generate a visual model 706 of enterprise-level software applications for design and development purposes. According to the current invention, the tool may be employed to generate a visual model 706 illustrating how an existing application or application path executes and/or how data is being accessed, as is described above. The visual model 706 may be in the form of one or more MDL files, for instance. This visual model provides a pictorial representation of application execution, and further of the data and other resources accessed during execution.

Although in one implementation, the visual modeling tool is selected to be Rational® Rose®, any other modeling tool that generates a similar visual model of the application may be used in the alternative. If a different tool is employed, data processing logic 700 is adapted to generate formatted data 702 in a format that is compatible with the selected tool.

According to one aspect of the invention, the visual modeling tool 704 generates another data file 708 that is formatted for use by text generation logic 710. When visual modeling tool 704 is Rational® Rose®, the data in data file 708 is a Software Documentation Automation (SoDA) format. Text generation logic 710 manipulates the data file 708 to create a text file 712 that textually describes the operation of the application. For instance, the text file will describe the resources accessed by the application, data manipulated by the application, and so on.

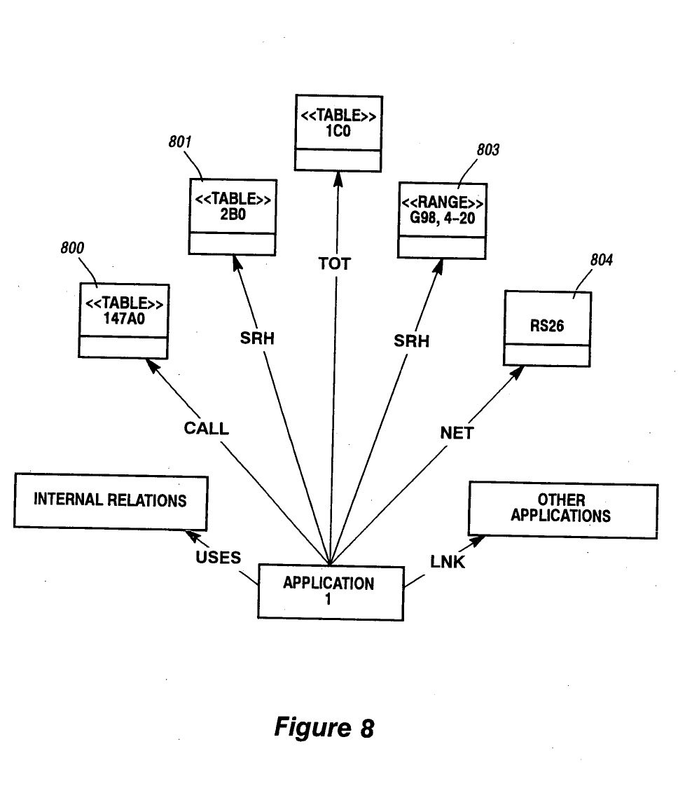

FIG. 8 is an exemplary visual model of an application “Application 1” and the resources that the application accesses. For instance, it uses the “CALL” command to reference Table 147A0 shown in block 800. Table 2B0 of block 801 is referenced using the “SRH” command, and so on. A range of tables G998 and 4-20 is also accessed using the “SRH” command, as shown in block 803. A data processing system “RS26” is accessed using the “NET” command, as illustrated by block 804. Internal relationships between Application 1 and other functions and/or subroutines are represented by the dashed line designated “LNK”.

In one embodiment, the diagram of FIG. 8 may be displayed on a user interface device, which may be a personal computer. A user may obtain more information about any of the “blocks” displayed in the diagram by selecting (as by “right-clicking” with a cursor device) on that block on the display. In one embodiment, this will provide more specific information about which data (e.g., row/column) within a table was accessed. For instance, more information can be obtained about the data in table 147A0 that was accessed by Application1 by selecting block 800. If the user wants to obtain more information about data processing system RS26, the user may select block 804, and so on.

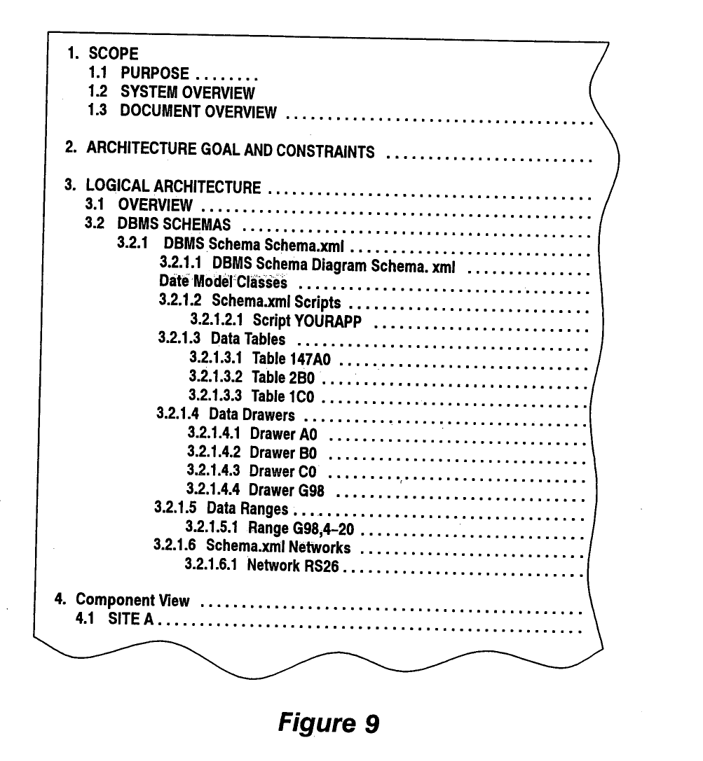

FIG. 9 is a table containing an excerpt from a text file that was generated from data collected according to the current invention. For example, Section 3.2.1.3 of the report contains information describing all of the data tables referenced by the application. Section 3.2.1.6 contains information involving the networks referenced by the application, and so on. Both this text file and the pictorial representation shown in FIG. 8 may be used by a designer to better understand the application so that modernization and maintenance may be performed for the application, programmable business rules may be developed in association with the application, maintenance and updates may be provided for the various systems utilized by the application, and so on.

Those skilled in the art will recognize that the methods, systems, and apparatuses described herein may be implemented using any combination of hardware and software. For example, some aspects of the invention may be implemented as digital logic circuitry. More typically, the functionality described relating to processor based devices may be implemented as programs that include processor executable instructions and embedded program data. From the description provided herein, those skilled in the art are readily able to combine software created as described with appropriate general purpose or special purpose computer hardware to create a computer system and/or computer subcomponents embodying the invention, and to create a computer system and/or computer subcomponents for carrying out methods embodying the invention.

Other aspects and embodiments of the present invention will be apparent to those skilled in the art upon consideration of the specification and practice of the invention disclosed herein. It is intended that the specification and illustrated embodiments be considered as examples only, with a true scope and spirit of the invention being indicated by the following claims.

What is claimed is:

1. A system for analyzing a software application, comprising:
collection enabling logic coupled to intercept application requests issued by the software application, and to determine based on a first set of programmable parameters, whether data collection is to occur for the application requests;
data selection logic coupled to receive the application requests, and if the data collection is to occur, to determine based on a second set of programmable parameters, which data is to be collected for each of one or more portions of the application request; and
retentive storage coupled to store the data to be collected to a file for analysis.

2. The system of claim 1, wherein the collection enabling logic is adapted to intercept a user request issued by a user to the software application, and to determine based on the first set of programmable parameters, whether data collection is to occur for any one or more of the application requests resulting from the user request.

3. The system of claim 2, wherein the first set of programmable parameters includes any descriptor that describes at least one of the user request and any of the application requests.

4. The system of claim 1, further including a user interface device coupled to the collection enabling logic to allow an authorized user to programmably select at least one of the first and the second sets of programmable parameters.

5. The system of claim 1, including request interpretation logic to translate each of the application requests into multiple portions.

6. The system of claim 5, wherein each of the multiple portions is a command recognizable by a database management system.

7. The system of claim 1, and further including a database management system to execute each of the one or more portions of the request by accessing at least one database.

8. The system of claim 1, wherein the data to be collected for each of the one or more portions of the application request includes at least one of a group consisting of:
a system name, a file name, a table identifier, a table column, a table row, range of report identifiers, a subroutine name, a function name, a script name, an object name, a data name, a communication path identifier, a device queue identifier, data returned in response to the application request, status returned in response to the application request, and an error code returned in response to the application request.

9. The system of claim 1, wherein the first set of parameters includes at least one of a group consisting of an application name, a script name, a station identifier, a run identifier, a user id, a dispatcher, a mode, an enable nesting parameter, a begin time, a begin date, a Boolean logic operator, a Boolean logic equation, a report name, a table column, a record identifier, a record range, a drawer, a cabinet, a database, a database type, a data location, a data processing system ID, a communication network ID, and an ID of a retentive storage device.

10. The system of claim 1, wherein the second set of programmable parameters utilizes decisional logic to determine which data is to be collected for at least one of the one or more portions of the application request.

11. A computer-implemented method for analyzing a software application, comprising:
receiving a user request to initiate execution of a software application;
in response to the user request, issuing by the software application an application request;
determining based on a first set of programmable parameters, whether at least one of the user request and the application request are of a type to trigger data collection;
translating the application request into one or more request portions; and
storing data associated with selected ones of the one or more request portions based on a second set of programmable parameters, the data for use in analyzing the software application.

12. The method of claim 11, further including for each of the one or more request portions, determining which data is to be stored for the request portion based on corresponding ones of the second set of programmable parameters.

13. The method of claim 12, and further including allowing an authorized user to select at least one of the first set and the second set of programmable parameters.

14. The method of claim 11, wherein the translating of the application request includes translating the application request into one or more commands recognized by a DataBase Management System (DBMS).

15. The method of claim 14, wherein the DBMS issues one or more queries to one or more databases, and wherein the storing of data includes at least one of storing selected data describing the one or more queries and storing selected data describing a response to the one or more queries.

16. The method of claim 11, including at least one of:
using the stored data to automatically generate a pictorial representation of the software application; and using the stored data to automatically generate a textual representation of the software application.

17. The method of claim 11, further including defining a disabling event, the occurrence of which disables at least one of the determining and the storing data.

18. The method of claim 17, wherein the disabling event is defined using one or more of the first set of programmable parameters.

19. The method of claim 11, further including issuing, by an authorized user, a command to enable the determining and the storing data.

20. A digital medium storing instructions to cause the data processing system to execute a method, comprising:
issuing, by a software application, an application request;
determining based on a first set of programmable parameters, whether the application request is of a type to trigger data collection;
translating the application request into multiple request portions;
using a second set of programmable parameters to determine, for each of the multiple request portions, if data is to be collected for analysis for the portion, and if so, which data is to be collected for analysis of the portion; and
storing, for each of the one or more request portions, any data to be collected for the portion for use in analyzing the software application.

21. The method of claim 20, wherein the application request is a script issued to a database management system, and wherein the translating includes translating the application request into multiple commands recognized by the database management system.

22. The method of claim 21, wherein the second set of programmable parameters selects for storing, for at least some of the multiple commands, at least one of a data item that is associated with a database query resulting from the command and a data item associated with a response issued as a result of the database query.
